(19) United States
(12) Patent Application Publication
(10) Pub. No.: US 2025/0369622 A1
(43) Pub. Date: Dec. 4, 2025

(54) COMMERCIAL COOKING APPLIANCE AND METHOD FOR OPERATING SUCH A COOKING APPLIANCE

(71) Applicant: MKN MASCHINENFABRIK KURT NEUBAUER GMBH & CO. KG, WOLFENBÜTTEL (DE)

(72) Inventors: KAY HÖRSTER, WOLFENBÜTTEL (DE); MARIAN KACZMARCZYK, WOLFENBÜTTEL (DE)

(21) Appl. No.: 19/108,106

(22) PCT Filed: Aug. 21, 2023
(86) PCT No.: PCT/EP2023/072952

§ 371 Date: Feb. 28, 2025

(30) Foreign Application Priority Data
Sep. 9, 2022 (DE) 10 2022 123 069.4

(51) Int. Cl. F24C 14/00; B08B 9/093

(52) U.S. Cl. CPC F24C 14/005; B08B 9/0936

(57) ABSTRACT

A commercial cooking appliance comprises a cooking chamber, in particular in the form of a pan, a lid for closing the cooking chamber, a cleaning device for cleaning the cooking chamber, the cleaning device being formed as a high-pressure device and comprises a cleaning head having at least one outlet opening for dispensing a cleaning fluid, and a drive device comprising a motor for rotationally driving the cleaning head. The cleaning head is mounted on the lid to be rotatable about a first axis of rotation and the motor of the drive device is received in an interior space of the lid.

### BACKGROUND OF THE INVENTION

The present invention relates to a commercial cooking appliance comprising a cooking chamber, in particular in the form of a pan, a lid for closing the cooking chamber, and a cleaning device for cleaning the cooking chamber. Furthermore, the present invention relates to a method for operating such a cooking appliance.

In cooking appliances of this kind, an interior of a pan can form the cooking chamber, for example as provided in pan-shaped or tub-shaped cooking chambers of cooking appliances used for preparation of liquid, creamy or pourable foods, such as soups, goulash, stews, pasta, rice or vegetables, such as peas, carrots or beans, or for frying food on the bottom of the pan, for example eggs or meat. The cooking chamber can be closed by the lid in order to prevent unwanted heat dissipation from the cooking chamber. In a number of suitably equipped appliances, this also allows pressure cooking.

Such cooking appliances are used in commercial kitchens, for example in canteens or restaurants, with a high throughput of food and dishes. After a corresponding process of food preparation in the cooking chamber or pan, the latter has to be thoroughly cleaned, in particular due to hygiene regulations, which is therefore often the case with commercial cooking appliances.

In the case of manual cleaning, the lid of the pan is opened, and a user applies a cleaning fluid to the cooking chamber using a hand-held shower, which cleaning fluid contains a chemical cleaning agent and has to act for a certain period of time, possibly with the addition of heat. Once the cleaning fluid has acted for a period of time, the user performs mechanical cleaning, for example by means of brushes, and removes food residues from the walls of the cooking chamber. The cooking chamber then has to be flushed in order to completely remove the residual washing liquor, and in particular the cleaning fluid, from the cooking chamber. Manual cleaning consumes large amounts of water and cleaning agents and also requires a lot of time and effort on the part of the user, who during this time is tied to the cooking appliance for cleaning.

Cleaning devices for cooking appliances with a tub-shaped cooking chamber sometimes provide spray nozzles or sprinklers for supplying a cleaning fluid into the cooking chamber and for wetting the walls of the cooking chamber with the cleaning fluid. Such systems, in which a circulation of the cleaning fluid or washing liquor takes place, as disclosed in EP 1 275 334 A2, must also comprise assemblies for filtering the cleaning solution, and a reservoir. Although this more complex and expensive design can partially disburden the user, mechanical cleaning of the cooking chamber by the user is usually still necessary.

In order to overcome these disadvantages, EP 2 724 082 A1 discloses a cleaning device for a generic cooking appliance in which water is introduced into the cooking chamber under high pressure via a cleaning head equipped with nozzles. The high-pressure jets of water allow the cooking chamber to be mechanically cleaned with water, and it is usually not necessary to add a chemical cleaning agent and allow it to act. Cleaning of the cooking chamber can also be partially automated, since intensive mechanical cleaning by the user is not required.

Nevertheless, the cleaning device described in EP 2 724 082 A1 also has disadvantages. The cleaning head provided with nozzles is arranged, for example, at one end of a lance, which is to be attached to a rear wall of the pan by means of a corresponding coupling. To cook food in the cooking chamber, it is necessary to remove the lance and cover the coupling with a suitable cap. The lance has to be stored on the cooking appliance or near the cooking appliance, which takes up additional space and may hinder the user when using the cooking appliance. When the cooking process is complete, the cap has to be removed using a tool and the lance has to be fetched and mounted in the pan. Depending on the skill of the user, the assembly and disassembly of the lance takes up more or less time, during which the user is not available for other tasks. Due to the frequent changing of the lance, signs of wear may also appear, in particular at the coupling, which is also subject to high forces due to the high pressure used. In order to place the cleaning head as centrally as possible in the cooking chamber, the lance extending from the rear wall is relatively long. This can lead to what is called a spray shadow, in which the emitted water jets do not reach the wall of the cooking chamber or do not reach it at sufficient pressure, as a result of which manual cleaning may be necessary at these locations.

### SUMMARY OF THE INVENTION

It is an object of the present invention to provide a commercial cooking appliance with a cleaning device and a method for operating such a cooking appliance, which cooking appliance and method, with at least the same or better cleaning results, enable increased automation of the cleaning process, lessen the work of the user and can be implemented easily and cost-effectively.

According to an aspect of the present invention, a commercial cooking appliance comprises a cooking chamber, in particular in the form of a pan, a lid for closing the cooking chamber, and a cleaning device for cleaning the cooking chamber. The lid has an upper side, an underside and at least one side wall, which connects the upper side and the underside to each other, wherein the upper side, the underside and the at least one side wall define an interior space of the lid. When the lid is closed, the cooking chamber is limited by the underside. The cleaning device is formed as a high-pressure device and is configured to feed a cleaning fluid, in particular water, into the cooking chamber under high pressure, wherein the cleaning device comprises a cleaning head, which has at least one outlet opening for dispensing the cleaning fluid. The cooking appliance further comprises a drive device which is provided to rotationally drive the cleaning head and which comprises a motor. The cooking appliance according to this aspect of the invention is characterized in that the cleaning head is mounted on the lid to be rotatable about a first axis of rotation, and in that the motor of the drive device is received in the interior space of the lid.

In this way, a cooking appliance is provided in which the motor-driven cleaning head of the high-pressure cleaning device is mounted on the lid. This has several advantages as described below.

By rotationally driving the cleaning head by means of the motor in conjunction with the high-pressure supply of the cleaning fluid, in particular of water, food residues can be mechanically removed from the entire cooking chamber, as a result of which the cleaning result can at least be maintained. Manual cleaning and the addition of a chemical cleaning agent are not required. The cleaning fluid is therefore preferably water. No (cleaning) additives are then added to the water. By receiving the motor in the lid and, thus, together with the mounting of the cleaning head, it is possible to do without complex torque-transmitting devices for transmitting the torque to the cleaning head.

Due to the arrangement of the cleaning head on the lid, when the lid is opened, the cleaning head is automatically moved out of the cooking chamber and its access opening, and therefore it does not impede the user when introducing food into the cooking chamber or when removing food from the cooking chamber. When the lid is closed, the cleaning head is automatically positioned within the cooking chamber, e.g. in order to start a cleaning process. In principle, the cleaning head is mounted in such a way that it is assigned to the underside of the lid or is arranged on the underside. The cleaning head can be mounted on a component forming the underside, e.g. on a covering part of the lid, or on a frame of the lid supporting the underside of the lid.

The cooking appliance may comprise a housing to which the lid is pivotably connected and which has the cooking chamber. Both, the lid and the housing, may each have a frame and a cover in a manner known per se. In general, the lid is movable, preferably pivotable about a pivot axis, between a closed state, in which it closes the cooking chamber and the underside of the lid limits the cooking chamber on one side, and an open state, in which the lid clears the access opening of the cooking chamber. The shape of the lid largely depends on the shape of the cooking chamber. In case of a substantially round cooking chamber, the lid also has a substantially round shape and then usually has only one circumferential side wall. In case of a pan-shaped or tub-shaped cooking chamber, the lid usually has a substantially rectangular shape with four side walls. If the cooking chamber is formed as a pan, it preferably has a bottom and four walls, wherein a rear first wall and a front second wall are opposite each other and a lateral third wall and a lateral fourth wall are opposite each other, which walls limit the cooking chamber, except for the access opening that can be closed by the lid. The cooking chamber may be heatable, wherein, in the case of a pan, corresponding heating elements may, for example, be provided in the walls and/or the bottom. By integrating several heating elements in the bottom, delimited cooking zones may be formed which may be controlled separately, as a result of which different temperatures of the cooking zones can be set.

The arrangement of the cleaning head on the lid also allows the cleaning head to be arranged at almost any distance from the walls of the cooking chamber without changing, or making particularly long, a length of a shaft or lance carrying the cleaning head. In the closed state of the lid, the cleaning head is preferably arranged substantially centrally between the first and the second wall and substantially centrally between the second and the third wall. By virtue of this arrangement of the cleaning head as centrally as possible on the lid, all the walls of the cooking chamber can be well cleaned, without the need for a relatively long shaft or lance that has the disadvantages described above. “Substantially centrally” means that the cleaning head may deviate from the exact center between the first and the second wall or between the third and the fourth wall by up to 10%, preferably by up to 5%, of the distance of the respective walls.

Rather, the cleaning head can be arranged relatively close to the underside of the lid without negatively affecting the cleaning result, as a result of which a shaft or a lance can be short and a spray shadow caused by said shaft or lance can be minimized or eliminated. A distance between a center point of the cleaning head and the underside of the lid is preferably only between 15 mm and 50 mm, more preferably between 20 mm and 40 mm, even more preferably between 25 mm and 30 mm. The cleaning head may have a diameter of between 20 mm and 50 mm, preferably of between 30 mm and 40 mm.

When the lid is closed, the cleaning head is located in the cooking chamber. A maximum filling level may be defined for the cooking chamber, up to which filling level the cooking chamber is allowed to be filled with food for cooking. When the lid is closed, the cleaning head is preferably arranged above the maximum filling level in the cooking chamber. This is facilitated by the arrangement of the cleaning head close to the underside of the lid.

It is particularly advantageous that the cleaning head can remain firmly mounted on the lid and does not have to be removed during the cooking process. Above all, this saves the user the time and effort involved in assembly and disassembly, and wear and worn parts can be reduced by the omission of assembly/disassembly and of the necessary coupling device. Once the food has been removed from the cooking chamber, a cleaning process can be started without the user having to take any further precautions. Also, no space needs to be provided for storing the cleaning head during the cooking process.

Particularly thorough cleaning of the entire cooking chamber can be achieved if, according to a preferred embodiment, the at least one outlet opening is mounted in the cleaning head to be rotatable about a second axis of rotation in such a way that a rotational movement of the cleaning head about the first axis of rotation and a rotational movement of the at least one outlet opening about the second axis of rotation superimpose each other, wherein the first axis of rotation and the second axis of rotation intersect each other, preferably at an angle of 90°. In general, the first axis of rotation is preferably oriented perpendicular to the underside of the lid. By superimposition of the rotational movements, it is possible, even with a small number of outlet openings and with low water consumption, to ensure that the at least one emitted jet can sweep across the walls of the cooking chamber and thoroughly clean the cooking chamber.

For an even distribution of the cleaning fluid and thus for uniform and thorough cleaning, it may also be of advantage if the cleaning head has a plurality of outlet openings, for example two, three or four outlet openings, for dispensing the cleaning fluid. The plurality of outlet openings can be evenly distributed around the second axis of rotation, wherein the outlet openings may be oriented in different directions, preferably in radial directions with respect to the second axis of rotation.

In order to dispense defined jets of the cleaning fluid at high pressure, the at least one outlet opening preferably has a diameter of between 0.2 mm and 5 mm, more preferably of between 0.4 mm and 2 mm, even more preferably of between 0.6 mm and 0.8 mm. In a preferred embodiment, the sum of the cross-sectional areas of all outlet openings, i.e., of the one outlet opening or of the plurality of outlet openings is between 1 mm² and 2 mm², more preferably between 1.2 mm² and 1.4 mm². In this way, it can be achieved that, on the one hand, the at least one outlet opening cannot become clogged due to particles in the cleaning fluid, in particular in the water, and, on the other hand, the high pressure can be maintained.

A volumetric flow of the cleaning fluid, in particular of the water, which is discharged from the at least one outlet opening or from the plurality of outlet openings is preferably between 10 l/min and 20 l/min, more preferably between 12 l/min and 15 l/min. This allows a good cleaning result to be achieved while maintaining high pressure and limiting the consumption of cleaning fluid, in particular the consumption of water.

In a preferred embodiment, the cleaning device comprises a bearing arrangement which is fixed to the lid and which comprises a rotary shaft which is rotatably mounted, which defines the first axis of rotation and on which the cleaning head is mounted by a torque proof connection. By means of the bearing arrangement, the cleaning head is preferably firmly connected to the lid and is non-detachable from the same, so that any assembling and disassembling effort on the side of the user is safely avoided and the cleaning head is permanently mounted on the lid. In this case, “non-detachable” means that the cleaning head cannot be removed from the lid by the user, in particular not without the use of tools, but may be dismantled for maintenance or repair work. The bearing arrangement is preferably received in the interior space of the lid, so that the rotary shaft is rotatably mounted in the interior space of the lid, for example by means of suitable rolling or plain bearings. The cleaning head may be mounted on the rotary shaft by means of known shaft-hub connections, for example by means of a splined shaft connection.

Receiving the motor in the interior space of the lid has the advantage that the cleaning head can be driven by motor in order to achieve the desired cleaning result and yet can be mounted on the movable lid. This eliminates the need to mount the cleaning head on a stationary component of the cooking chamber, or to transmit a drive movement into the lid with great difficulty, if at all. It is further preferred if the drive device comprises a torque transmission device for transmitting a torque from the motor to the rotary shaft, and the torque transmission device is likewise received in the interior space of the lid. Thus, the drive device comprising the motor and the transmission device is provided in a compact manner in the interior space of the lid, at the point where the torque is required to drive the rotary shaft.

Preferably, the motor is an electric motor, in particular a permanent-magnet DC motor. The motor may have a length, in an axial direction of an output shaft of the motor, of between 80 mm and 200 mm, more preferably of between 100 mm and 150 mm, and a diameter of between 20 mm and 60 mm, more preferably of between 30 mm and 50 mm. The motor is preferably operated with a protective low voltage according to IEC 60449. Preferably, a nominal voltage of the motor is 24 V DC. A nominal voltage of 12 V DC would also be conceivable.

The output shaft of the motor is preferably oriented perpendicular to the first axis of rotation. The transmission device may comprise a bevel gear, wherein preferably a driving bevel gear is mounted on the output shaft of the motor in a torque proof manner, and a driven bevel gear is mounted for on the rotary shaft in a torque proof manner. The driving bevel gear and the driven bevel gear engage with each other.

The rotary shaft has a first end portion, on which the cleaning head is mounted, and a second end portion, to which the torque is preferably transmitted. Consequently, the first end portion of the rotary shaft is located outside the lid and the second end portion is located within the interior space of the lid, and the rotary shaft extends through the underside of the lid.

The bearing arrangement preferably comprises a stub surrounding the first end portion of the rotary shaft. The stub may be fixed to the lid or to a component of the bearing arrangement and may have a through-opening through which the rotary shaft extends. The stub is preferably provided at least between the underside of the lid and the cleaning head, but it may also partially extend into the lid.

In an advantageous embodiment, the stub has a substantially conical shape between the underside of the lid and the cleaning head. More precisely, the stub has a shape tapering toward the cleaning head. That is, a radius of the stub radially with respect to the first axis of rotation at an end facing the cleaning head is smaller than a radius of the stub at an end facing the lid. Preferably, a lateral surface of the stub is curved concavely and can run out flush with the underside of the lid. This shape of the stub ensures that a jet of the cleaning fluid emanating from the at least one outlet opening strikes the lateral surface of the stub and is deflected by the latter, so that the stub is cleaned and a spray shadow caused by the stub or the rotary shaft can be minimized or eliminated.

If the at least one outlet opening is mounted in the cleaning head to be rotatable about the second axis of rotation, as is described above, the stub can realize a further advantageous function irrespective of the substantially conical shape. To generate a rotational movement of the at least one outlet opening about the second axis of rotation, the stub can engage with the cleaning head in such a way that the rotational movement of the at least one outlet opening about the second axis of rotation is generated as the cleaning head rotates about the first axis of rotation.

In this case, the at least one outlet opening is preferably provided in a carrier of the cleaning head, which carrier is mounted in the cleaning head to be rotatable about the second axis of rotation. The carrier may have a first bevel gear wheel, which can be formed integrally with the carrier or, as a separate component, can be mounted on the latter in a torque proof manner. The stub has a second bevel gear wheel, which can be formed integrally with the stub or, as a separate component, can be mounted on the latter in a torque proof manner. The first and second bevel gear wheels engage with each other. Preferably, the first bevel gear wheel is arranged coaxially with respect to the second axis of rotation, and the second bevel gear wheel is arranged coaxially with respect to the first axis of rotation.

This allows the superimposed rotational movement of the at least one outlet opening to be generated as follows. The rotary shaft is rotationally driven about the first axis of rotation, as a result of which the cleaning head connected to the rotary shaft in a torque proof manner also rotates about the first axis of rotation. With the cleaning head, the carrier and the first bevel gear wheel also rotate about the first axis of rotation, wherein the first bevel gear wheel engages with the second bevel gear wheel, rolls off on the latter and is thus rotated about the second axis of rotation. With the carrier, the at least one outlet opening also rotates about the second axis of rotation. The same applies to a plurality of outlet openings.

For supplying the cleaning fluid, the cleaning device preferably comprises a fluid line, which is formed as a high-pressure line, in particular as a pressure hose, and is at least partially received in the interior space of the lid. In this way, the high-pressure cleaning fluid, particularly water, can be routed particularly easily into the lid and in the direction of the cleaning head. The fluid line is fluidically connected to the cleaning head, in particular to the at least one outlet opening.

The cooking appliance, which comprises the housing in which the cooking chamber is formed, particularly advantageously has a hose feed-through between the lid and the housing, preferably in the region of the pivot axis of the lid. The fluid line may extend from the bearing arrangement within the interior space of the lid to the hose feed-through and through the hose feed-through into the housing. Parallel to the fluid line, at least one supply line for supplying the motor with power and control signals may extend from the housing into the lid and to the motor.

The cleaning device may comprise a pump, in particular a high-pressure pump, which provides the cleaning fluid under high pressure and to which the fluid line is connected. In general, the cleaning device is preferably configured to provide the cleaning fluid under high pressure, which is between 40 bar and 300 bar, more preferably between 60 bar and 250 bar, even more preferably between 100 bar and 200 bar. Particularly good cleaning results can be achieved with a high pressure of more than 100 bar, e.g. with at least 120 bar, at least 140 bar or at least 160 bar. With high pressure in the previously specified range, it can be ensured that the cleaning fluid emanating from the at least one outlet opening has a sufficiently high pressure for mechanical cleaning of the cooking chamber in order to remove even stubborn residues. Lower pressures, for example in the range of 1 bar to 20 bar, are usually not sufficient to remove all residues from the walls of the cooking chamber, which means that the desired cleaning result is not achieved. Of the specified preferred ranges of high pressure, all intermediate values, in particular in whole bar values, are to be included in the present disclosure. Above all, the upper and lower limits of the specified values can also be changed independently of each other, e.g. in steps of 5 bar.

In a preferred embodiment, the fluid line, in particular in the form of the pressure hose, is connected to the bearing arrangement. Despite the rotation of the rotary shaft and of the cleaning head, the connection of the fluid line remains stationary. The bearing arrangement may have a fluid chamber, which is fluidically connected to the fluid line. The rotary shaft may be formed in sections as a hollow shaft and may have a supply channel, which is fluidically connected to the fluid chamber and to the cleaning head. In this way, the high-pressure cleaning fluid can be conveyed into the cleaning head without providing complex and expensive piping and sealing systems.

For example, the rotary shaft has an axial supply channel, which extends from a face of the rotary shaft facing the cleaning head to the height of the fluid chamber and is fluidically connected to the fluid chamber by means of a radial opening.

In principle, the bearing arrangement may comprise a bearing body in which the rotary shaft is mounted rotatably. For example, the bearing body is formed in the shape of a sleeve or a bushing and surrounds the rotary shaft, which is supported in the bearing body by means of suitable bearings, such as rolling or plain bearings. Furthermore, the fluid chamber may be formed in the bearing body, and the connection for the fluid line may be provided on the bearing body. It goes without saying, however, that the bearing of the rotary shaft and the connection of the fluid line can also be realized by various components.

In order to achieve a space-saving arrangement in the lid, the bearing arrangement is preferably received between the motor and the fluid line. The motor and the fluid line are arranged opposite each other with respect to the bearing arrangement. This may be the case irrespective of the exact design of the bearing arrangement and of the fluid line. The motor, the bearing arrangement and the fluid line may therefore be arranged in a row in a direction perpendicular to the first axis of rotation and preferably perpendicular to the pivot axis.

This space-saving arrangement is particularly advantageous if the lid comprises a plurality of hollow profiles for stiffening the lid and if the motor and preferably the bearing arrangement and at least a part of the fluid line are received in a hollow profile of the plurality of hollow profiles. Stiffening the lid by means of the plurality of hollow profiles allows the cooking appliance to be used for pressure cooking, which can shorten the cooking time. Despite the resulting increased requirements on the lid, the motorized cleaning head can be provided on the lid. The plurality of hollow profiles preferably extends parallel to one another in a first direction perpendicular to the first axis of rotation, wherein the hollow profiles are arranged spaced apart from one another in a second direction perpendicular to the first direction. The first direction is preferably also oriented perpendicular to the pivot axis.

For pressure cooking, the lid and thus the cooking chamber are tightly closed. For safety reasons, the lid is locked. In the cooking chamber, pressure cooking can be carried out at a pressure of between 0.2 bar and 1 bar, preferably of between 0.3 bar and 0.9 bar, more preferably of between 0.4 bar and 0.8 bar.

Each hollow profile of the plurality of hollow profiles has, for example, a substantially rectangular cross section. A width of each hollow profile, independent of the other hollow profiles, may be between 80 mm and 160 mm, preferably between 100 mm and 140 mm, more preferably between 110 and 120 mm. A height of each hollow profile, independent of the other hollow profiles, may be between 40 mm and 70 mm, preferably between 50 mm and 60 mm.

To ensure that the bearing arrangement and preferably also the drive device, which are arranged in the interior space of the lid, can be easily installed and maintained, the lid may have a closable access opening on the upper side, through which access opening at least the bearing arrangement, and preferably also the drive device having the transmission device and the motor, are accessible. If these are received in a hollow profile, as previously described, the access opening extends through the upper side of the lid and the hollow profile. In this way, the bearing arrangement, with the cleaning head mounted on thereon, can be inserted into and removed from the lid from above.

Preferably, the access opening can be closed by means of a cover, for example a cap or flap. To avoid unwanted manipulation, it is preferred that the cover cannot be opened by the user. The cover may be made of a material with good heat conduction characteristics, which allows heat in the interior space of the lid to be readily dissipated into the top of the lid and into the surroundings. Furthermore, the cover may have a lighting device which, for example, signals the operation of the cleaning device.

The cooking appliance according to an aspect of the present invention has been described in detail above. Evidently, the cleaning device is particularly advantageous for commercial cooking appliances, which are designed for preparing large quantities and for a high throughput. For example, the cooking chamber of such cooking appliances may have a useful capacity (corresponding to the maximum filling level) of at least 50 liters and of up to 150 liters or more. Commercial cooking appliances are usually stationary and may be permanently connected to the water and sewage networks. Alternatively, the cooking appliances may be provided on rollers. In order to simplify the handling of large quantities of liquid food, for example, the cooking chamber, e.g. in the form of a pan within the housing, may be tiltable, in particular tiltable by a motor, as is known from tilting bratt pans. In addition, the lid may be lockable, in particular lockable by a motor. This is particularly necessary for pressure cooking. In general, the cooking appliance according to the invention can be used, among other things, for frying, cooking, deep-frying and pressure cooking.

According to another aspect of the present invention, a method for operating the cooking appliance comprises the following steps:
cooking of a food product in the cooking chamber of the cooking appliance, wherein the cleaning head of the cleaning device is attached firmly to the lid during cooking and is located in the cooking chamber of the cooking appliance;
terminating the cooking process and removing the food product when a desired level of cooking of the food product is reached; and
automatic cleaning of the cooking chamber by means of the cleaning device after removing the food product.

In this way, a method for operating the cooking appliance is provided, by which the work of the user of the cooking appliance is lessened and at the same time a very good cleaning result is achieved.

Since the method is carried out by means of the cooking appliance, all of the features and advantages described with respect to the cooking appliance also apply to the method. It should be emphasized that the cleaning head of the cleaning device can remain on the lid during all steps of the method, as a result of which the work of the user is reduced and automated cleaning is enabled.

In one embodiment, the cooking appliance may notify the user of an end of a cooking program, for example visually and/or acoustically. In addition or alternatively, the cooking appliance may detect a degree of cooking of the food by means of a sensor device, for example a core temperature sensor or a camera, and can notify the user when a certain degree of cooking has been reached.

The user can then remove the food from the cooking chamber and start the cleaning process. For example, the user confirms the start of the cleaning process by way of a control and display device of the cooking appliance, such as suitable buttons or a touch display. The cooking appliance may be configured to, after completion of a cooking program, after reaching a certain degree of cooking and/or after removal of the food from the cooking chamber, display a choice box to the user for starting the cleaning process, which is to be confirmed by the user simply by selection. The cleaning process can then be started and carried out without any further action by the user.

Cleaning the cooking chamber is preferably carried out exclusively with water as a cleaning fluid, which is introduced at high pressure into the cooking chamber by the cleaning head, which rotates at least about the first axis of rotation. This will remove residues from the walls and from the bottom of the cooking chamber and thoroughly clean the cooking chamber. A chemical cleaning agent is not admixed. It may sometimes be desirable or necessary to descale the cooking appliance and particularly the cleaning device. For this purpose, for example, a descaling agent can be added that flows through the lines of the cleaning device. During this process, the fluid is usually not pumped at high pressure.

### BRIEF DESCRIPTION OF THE DRAWINGS

FIG. 1 shows schematically a perspective view of a cooking appliance, with a cooking chamber in the form of a pan and with an open lid.

FIG. 2 shows schematically a sectional view of the cooking appliance along the plane E-E in FIG. 1, with the lid closed, and a schematically indicated cleaning process.

FIG. 3 shows a perspective sectional view of a detail of the lid of the cooking appliance according to FIGS. 1 and 2.

FIG. 4 shows in detail a sectional view of a cleaning device and a drive device of the cooking appliance.

FIG. 5a shows a sectional view of the cleaning device in a plane perpendicular to that in FIG. 4.

FIG. 5b shows a perspective view of a stub of the cleaning device according to FIG. 5a.

FIG. 6a shows a sectional view of a detail of the cooking appliance in the region of the pivot axis of the lid, with the lid closed.

FIG. 6b shows a sectional view of the detail according to FIG. 6a, with the lid open.

FIG. 7 shows a perspective view of a hose feed-through between the lid and a housing of the cooking appliance in the region according to FIG. 6.

FIG. 8 shows a detailed perspective view of the detail according to FIG. 6 and FIG. 7 in an alternative embodiment.

FIG. 9 shows a perspective view of a region of a pivot joint between the lid and the housing of the cooking appliance.

FIG. 10 shows a detailed perspective view of an element of the hose feed-through according to FIG. 8.

### DETAILED DESCRIPTION OF SPECIFIC EMBODIMENTS

In the figures, same elements are identified with the same reference numbers.

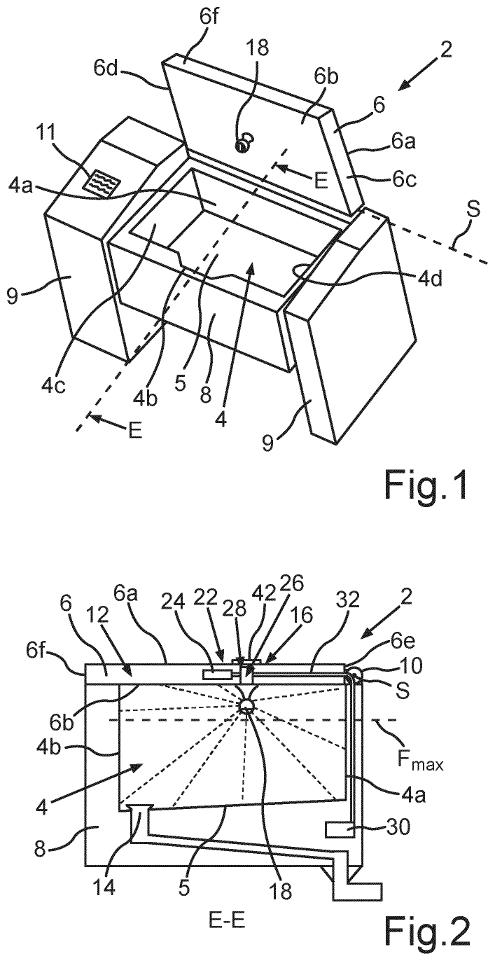

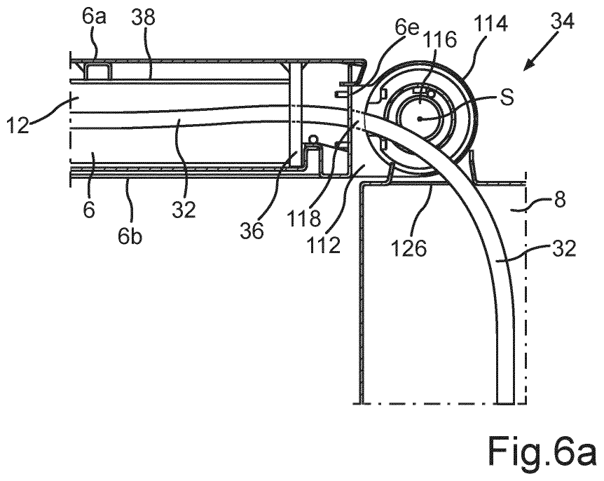

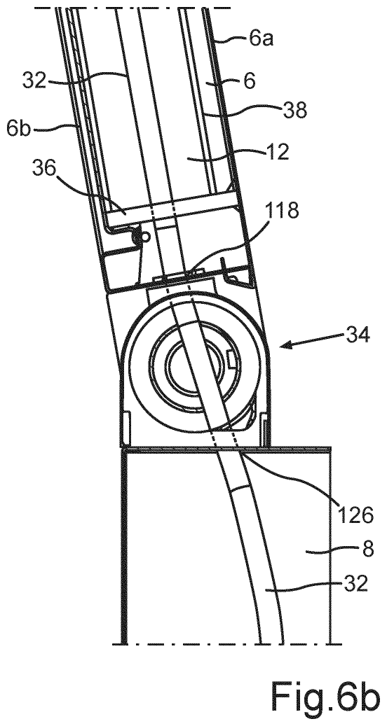

In FIGS. 1 and 2, a commercial cooking appliance 2 is shown schematically, wherein FIG. 1 shows a perspective view and FIG. 2 shows a sectional view along the plane E-E in FIG. 1. The cooking appliance 2 may comprise a cooking chamber 4 and a lid 6 for closing the cooking chamber 4, which lid 6 is pivotable about a pivot axis S between an open state (FIGS. 1 and 6b) and a closed state (FIGS. 2 and 6a). The sectional view according to FIG. 2 shows a section in a plane E-E perpendicular to the pivot axis S.

In the present embodiment, the cooking appliance 2 comprises a housing 8, and the cooking chamber 4 is formed as a pan 4 in the housing 8. At the same time, the housing 8 can form a base of the cooking appliance 2 or, as shown in FIG. 1, can be suspended in a frame or in supports 9, so as to be tilted about an axis parallel to the pivot axis S in order to pour food out of the cooking chamber 4 in a forward direction. Furthermore, the cooking appliance 2 may comprise a control and display device 11 for operating the cooking appliance 2 and for displaying information, for example concerning the cooking process or cooking programs.

The lid 6 may be mounted on the housing 8 pivotably about the pivot axis S by means of a rotary joint 10 (see FIG. 2) in order to open and close the cooking chamber 4. The lid 6 has an upper side 6a, an underside 6b and at least one side wall 6c, which connects the upper side 6a and the underside 6b. If the lid 6, as shown, is substantially rectangular or cuboid, the lid 6 has four side walls 6c, 6d, 6e, 6f. The upper side 6a, the underside 6b and the at least one side wall 6c, d, e, f define an interior space 12 of the lid 6. In the closed state of the lid 6 (FIG. 2), the underside 6b of the lid 6 limits the cooking chamber

In the case of the pan-shaped or tub-shaped cooking chamber 4, the cooking chamber 4 has a rear first wall 4a, a front second wall 4b, a lateral third wall 4c and a lateral fourth wall 4d, wherein the first and the second wall 4a, 4b are opposite each other and the third and the fourth wall 4c, 4d are opposite each other. In a downward direction, the cooking chamber 4 is limited by a bottom 5, which can have a drain 14 in order to be able to remove any dirt or liquid residues from the cooking chamber 4 through the bottom 5. The bottom 5 may be arranged substantially horizontally, e.g. as a frying plate, or slightly inclined, wherein in the latter case the drain 14 is preferably provided at the deepest point of the bottom 5. To heat the cooking chamber 4, corresponding heating elements (not shown) may be provided in the walls 4a, b, c, d and/or the bottom 5. The lid 6 is usually mounted on the upper edge of the rear first wall 4a by means of the rotary joint 10.

As an alternative to the tub-shaped or pan-shaped cooking chamber 4 shown here, the cooking chamber 4 may have different shapes, for example hemispherical, in the manner of a wok, or a circular cylindrical shape.

The cooking appliance 2 further comprises a cleaning device 16 for cleaning the cooking chamber 4 after the preparation of food in the cooking chamber 4, in order to prepare the latter for the next preparation process. The cleaning device 16 is formed as a high-pressure device. By supplying the cleaning fluid under high pressure, food residues can be removed mechanically from the walls 4a, 4b, 4c, 4d, the bottom 5, and the underside 6b of the lid 6. Pure water can be used as a cleaning fluid without the addition of chemical cleaning agents.

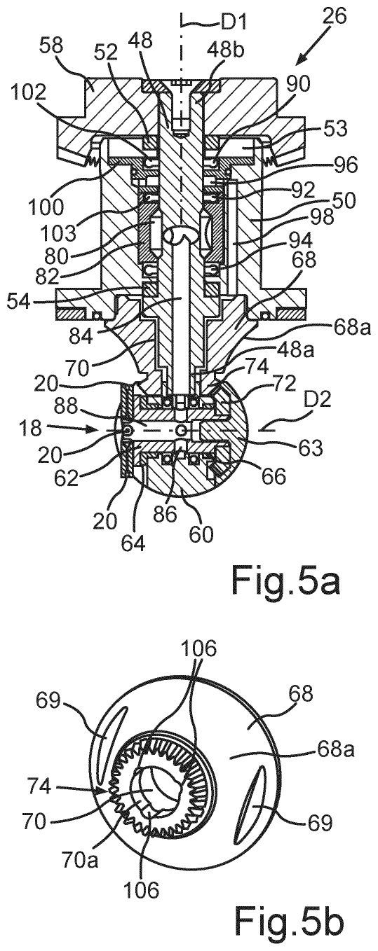

The cleaning device 16 comprises a cleaning head 18, which has at least one outlet opening 20, preferably a plurality of outlet openings 20 (see FIGS. 4 and 5a), for dispensing the cleaning fluid into the cooking chamber 4. In FIG. 2, jets of the cleaning fluid (e.g. water jets) emanating from the at least one outlet opening 20 are indicated in dashed lines; these jets do not emanate simultaneously but at least partially one after the other through the movement of the cleaning head. The use of water as cleaning fluid furthermore has the advantage that the wash liquor does not need to be recirculated, as would be customary with the addition of cleaning agents, whereby the at least one outlet opening having a very small diameter could become clogged due to particles in the wash liquor.

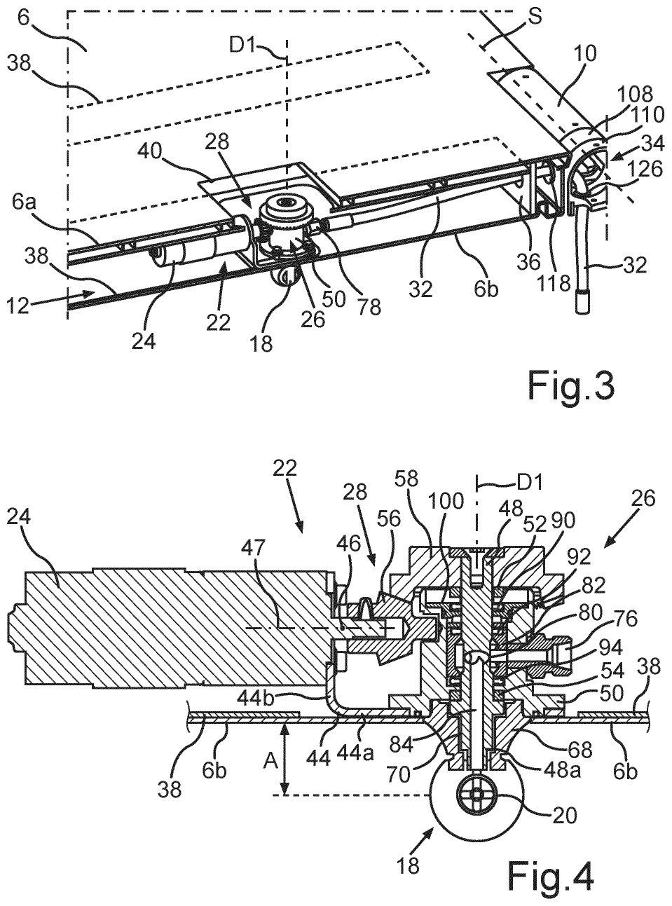

Furthermore, a drive device 22 comprising a motor 24 is provided for rotationally driving the cleaning head 18. According to an aspect of the invention, the cleaning head 18 is mounted on the lid 6 to be rotatable about a first axis of rotation D1 (see FIGS. 3 and 4), and at least the motor 24 of the drive device 22 is received in the interior space 12 of the lid 6. Due to the motor-driven rotation of the cleaning head 18 at least about the first axis of rotation D1, the cooking chamber 4 can be cleaned as completely and thoroughly as possible. In addition, by mounting the cleaning head 18 on the lid 6, a particularly advantageous arrangement of the cleaning head 18 in the cooking chamber 4 is made possible.

On the one hand, with the lid 6 closed, as shown in FIG. 2, the cleaning head 18 can be arranged substantially centrally between the rear first wall 4a and the front second wall 4b, and preferably substantially centrally between the lateral walls 4c, 4d and thus, in a horizontal plane, as centrally as possible in the cooking chamber 4. Thus, the walls 4a-d of the cooking chamber 4 can be readily impacted by cleaning fluid without a relatively long lance being required for this purpose, as in the prior art described at the outset, as a result of which a possible spray shadow can also be minimized or eliminated.

Furthermore, the cleaning head 18 can be arranged at a small distance A from the underside 6b of the lid 6, wherein the distance A between a center point of the cleaning head 18 and the underside 6b of the lid 6 is, for example, less than 50 mm, preferably less than 30 mm. By virtue of the small distance, a spray shadow possibly caused by the mounting of the cleaning head 18 can be further minimized or eliminated. In addition, a maximum filling level Fmax may be defined for the cooking chamber 4, up to which level the user is allowed to fill the cooking chamber 4 with food for cooking. The small distance of the cleaning head 18 from the underside 6b of the lid 6 enables the cleaning head 18 to be arranged completely above the maximum filling level Fmax, when the lid 6 is closed.

In particular, the mounting of the cleaning head 18 on the lid 6, by means of which the cleaning head 18 is moved out of the cooking chamber 4 and the working area of the user when the lid 6 is opened, and the space-saving arrangement near the underside 6b of the lid 6 advantageously have the effect that the cleaning head 18 can be permanently attached to the lid 6 and does not have to be assembled and disassembled by the user.

The cleaning device 16 may furthermore comprise a bearing arrangement 26 by means of which the cleaning head 18 is mounted rotatably in the lid 6. In principle, the cleaning head 18 is mounted on the lid 6 in such a way as to be assigned to the underside 6b of the lid 6. The drive device 22 preferably comprises a torque transmission device (hereinafter referred to simply as transmission device) 28 for transmitting a torque from the motor 24 to the bearing arrangement 26. Preferably, the bearing arrangement 26 and the transmission device 28 are also received in the interior space 12 of the lid 6, as shown.

For providing the cleaning fluid at high pressure, the cooking appliance 2 preferably comprises a (high-pressure) pump 30, which may be provided in the housing 8 of the cooking appliance 2. A fluid line 32, in particular in the form of a pressure hose 32, may be provided for feeding the cleaning fluid towards the cleaning head 18. The fluid line 32 is formed as a high-pressure line, preferably connected to the bearing arrangement 26 and partially received in the interior space 12 of the lid 6. The fluid line 32 may extend from the bearing arrangement 26 in the lid 6 to a hose feed-through 34, through which it can run from the lid 6 into the housing 8 and, as described in detail below, can extend from there to the pump 30 to which it is connected.

The drive device 22 with the motor 24 and with the transmission device 28 as well as the cleaning device 16 with the cleaning head 18 and with the bearing arrangement 26 are described in detail below with reference to FIGS. 3 to 5.

In FIG. 3, a detail of the lid 6 is shown in a perspective sectional view, in a section plane perpendicular to the pivot axis S. FIG. 4 shows the drive device 22, the bearing arrangement 26 and the cleaning head 18 in a sectional view through the first axis of rotation D1 and perpendicular to the pivot axis S, while FIG. 5a shows the bearing arrangement 26 and the cleaning head 18 in a sectional view through the axis of rotation D1 and perpendicular to the view according to FIG. 4.

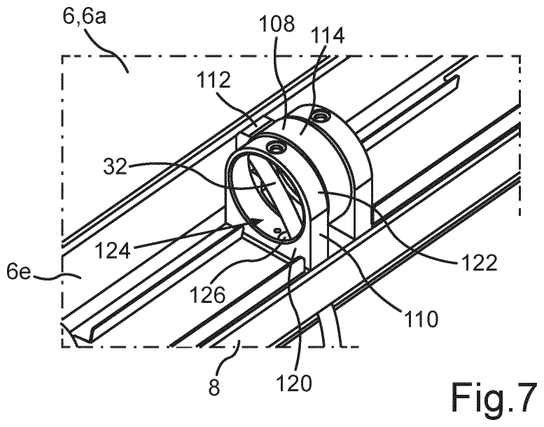

As can be seen in FIG. 3, the motor 24 and preferably the transmission device 28 and the bearing arrangement 26 are received in the interior space 12 of the lid 6. More specifically, the lid 6 may comprise a cover, for example of sheet metal, which forms the upper side 6a and the underside 6b of the lid 6, and a frame 36 as a support structure for the cover. In general, the lid 6 may comprise a plurality of hollow profiles 38 for stiffening the lid, which are indicated in part by dashed lines in FIG. 3, wherein a central hollow profile 38 is also shown in section. The hollow profiles 38 may have a rectangular cross section and may have a longitudinal direction which is preferably oriented perpendicular to the first axis of rotation D1 and to the pivot axis S. In this case, the motor 24 and preferably the transmission device 28 and the bearing arrangement 26 are arranged within the central hollow profile 38. As can be seen in FIG. 3, the fluid line 32 is also arranged in the lid 6 and optionally in the central hollow profile 38 and is routed from the bearing arrangement 26 in the lid 6 to the hose feed-through 34, through which it extends into the housing 8, as is described in more detail with reference to FIGS. 6 to 10.

So that the components arranged in the lid 6 can be mounted in the lid 6 and are accessible, for example, for maintenance purposes, the upper side 6a of the lid 6 may have an access opening 40 which, if present, may also extend through the central hollow profile 38. As indicated in FIG. 2, the access opening 40 may be closed by a cover 42 in order to avoid unwanted manipulation.

As is shown in FIG. 4, the motor 24 may be mounted on a holding bracket 44 in the interior space 12 of the lid 6. For example, the holding bracket 44 is L-shaped, wherein a first leg 44a is attached to the inner side of the lid 6, for example to a sheet metal forming the underside 6b of the lid 6. The motor 24 may be mounted, e.g. by screwing, on a second leg 44b of the holding bracket 44, the second leg 44b protruding perpendicularly to the first leg 44a into the interior space 12 of the lid 6. The holding bracket 44 may have an opening through which an output shaft 46 of the motor 24 extends.

The cleaning head 18 is rotatably mounted on the lid 6 by means of the bearing arrangement 26, the structure of which can be seen clearly in the sectional views according to FIGS. 4 and 5a. The bearing arrangement 26 can be fixed to the lid 6, for example on the inner side of the sheet metal forming the underside 6b. For example, threaded bolts can be welded to the inner side of this sheet metal, and the holding bracket 44 and the bearing arrangement 26 can have receptacles for these threaded bolts and are secured to them by nuts, as is shown in FIG. 3.

Preferably, the bearing arrangement 26 comprises a rotary shaft 48 which is rotatably mounted, which defines the first axis of rotation D1, and on which the cleaning head 18 is mounted by a torque-proof connection. For example, the cleaning head 18 is mounted on a first end portion 48a of the rotary shaft 48 by means of a shaft-hub connection, such as a splined shaft connection. The bearing arrangement 26 can furthermore comprise a bearing body 50 in which the rotary shaft 48 is rotatably mounted, here by means of a first plain bearing 52 and a second plain bearing 54. The plain bearing 52 may be accommodated in a bearing insert element 53, which is inserted into the bearing body 50. However, other bearings, such as rolling bearings, may also be used. The bearing body 50 may be in the form of a sleeve or bushing and have a flange for fastening the bearing body 50 to the lid 6.

The transmission device 28 is provided for transmitting a torque from the motor 24 to the rotary shaft 48. The output shaft 46 of the motor 24 has an axis 47, which is preferably oriented perpendicular to the first axis of rotation D1. In this case, the transmission device 28 may comprise a bevel gear. For this purpose, a driving bevel gear wheel 56 is mounted on the output shaft 46 of the motor 24 in a torque proof manner and a driven bevel gear wheel 58 is mounted on the rotary shaft 48 in a torque proof manner, in particular on a second end portion 48b of the rotary shaft 48 opposite the first end portion 48a. The driving bevel gear wheel 56 may furthermore have a shaft stub opposite the output shaft 46, which shaft stub is mounted rotatably in the bearing body 50, for example by means of a plain bearing. The driving bevel gear wheel 56 and the driven bevel gear wheel 58 engage with each other. A rotational movement of the output shaft 46 is thus transmitted via the bevel gear 56, 58 to the rotary shaft 48 and thus results in a rotation of the cleaning head 18 and thus of at least one outlet opening 20 about the first axis of rotation D1.

In order to achieve the best possible cleaning result even with a small number of outlet openings 20, the at least one outlet opening 20 in a particularly preferred embodiment is mounted in the cleaning head 18 to be rotatable about a second axis of rotation D2, such that the rotational movement of the cleaning head 18 about the first axis of rotation D1 and a rotational movement of the at least one outlet opening 20 about the second axis of rotation D2 superimpose each other. The first axis of rotation D1 and the second axis of rotation D2 intersect, here at an angle of 90°.

A structure of the cleaning head 18, which also allows a rotation of the at least one outlet opening 20 about the second axis of rotation D2, is described below with reference to FIG. 5a. The cleaning head 18 may comprise a head piece 60, which is mounted on the rotary shaft 48 in a torque proof manner, and which is rotatable with the latter about the first axis of rotation D1. The head piece 60 may have a through-opening which is coaxially aligned the second axis of rotation D2, in which through-opening a carrier 62 is mounted in the head piece 60 to be rotatable about the second axis of rotation D2, for example by means of plain bearings 64 and 66. The at least one outlet opening 20 is provided in the carrier 62, so as to be rotatable with the latter about the second axis of rotation D2. The outlet opening 20 may be formed by a nozzle which is attached to the carrier 62. In the illustrated embodiment, four nozzles are provided, each offset by 90°. If a plurality of outlet openings 20 are provided, these can be uniformly distributed about the second axis of rotation D2 and can be oriented in different directions, in particular in radial directions with respect to the second axis of rotation D2. A cap 63 of the cleaning head 18 may be provided on the carrier 62 opposite the outlet openings.

The bearing arrangement 26 may furthermore comprise a stub 68, which realizes a series of advantageous features and, in addition to the sectional views in FIGS. 4 and 5a, is shown in a perspective view in FIG. 5b. The stub 68 surrounds the first end portion 48a of the rotary shaft 48, in particular in the region outside the interior space 12 of the lid. The stub 68 may be connected to the bearing body 50 or to another (frame) component of the lid 6. For example, the stub 68 is screwed on, for which purpose its lateral surface may have wrench surfaces 69, which can engage with a open-ended wrench. The bearing body 50 may for this purpose have an internal thread portion and the stub 68 may have a corresponding external thread portion. Preferably, the stub 68 extends from the bearing body 50 to the cleaning head 18, wherein the rotary shaft 48 is received in this region in a through-opening 70 which passes through the stub 68 parallel to the first axis of rotation D1.

In an advantageous embodiment, the stub 68 is formed to engage with the cleaning head 18 in order to generate the rotational movement of the at least one outlet opening 20 about the second axis of rotation D2 during the rotation of the cleaning head 18 about the first axis of rotation D1. More precisely, the carrier 62 may have a first bevel gear wheel 72, which is formed integrally with the carrier 62 or which, as a separate component, is mounted on the latter in a torque proof manner. The stub 68 may have a second bevel gear wheel 74, which can be formed integrally with the stub 68 or, as a separate component, can be mounted on the latter in a torque proof manner. The first and second bevel gears wheels 72, 74 engage with each other. Preferably, the first bevel gear wheel 72 is arranged coaxially to the second axis of rotation D2, and the second bevel gear wheel 74 is arranged coaxially to the first axis of rotation D1. The stub 68 and thus the second bevel gear wheel 74 are stationary. When the rotary shaft 48 is rotated about the first axis of rotation D1, the cleaning head 18 and the carrier 62 likewise rotate with about the first axis of rotation D1. In this case, the first bevel gear wheel 72 of the carrier 62 rolls off on the second bevel gear wheel 74 and is thereby rotated about the second axis of rotation D2, as a result of which the at least one outlet opening 20 rotates about the second axis of rotation D2.

Particularly advantageously, and substantially independently of the above-described engagement with the cleaning head 18, the stub 68 has, between the underside 6b of the lid 6 and the cleaning head 18, a substantially conical shape which tapers from the underside 6b toward the cleaning head 18. In this case, the lateral surface 68a of the stub 68 may be curved, in particular concavely curved, and runs out flush with the underside 6b of the lid 6. Preferably, a radius of the stub 68 about the first axis of rotation D1 at its end facing the cleaning head 18 is smaller than a distance of the at least one outlet opening 20, or of a nozzle plane defined by a plurality of outlet openings 20, from the first axis of rotation D1.

The conical shape of the stub 68 is particularly hygienic due to the lack of edges and is cleaned by impact of the jets from the cleaning head 18 itself. In addition, the jets are deflected upon impact with the stub 68 and can contribute to cleaning the underside 6b of the lid 6. Any spray shadow is minimized.

As can be seen from FIGS. 2 and 3, the bearing arrangement 26 is received between the motor 24 and the fluid line 32, wherein the motor 24 and the fluid line 32 are arranged opposite each other with respect to the bearing arrangement 26. The motor 24, the bearing arrangement 26 and the fluid line 32 may therefore be arranged in a row in a direction perpendicular to the first axis of rotation D1 and preferably perpendicular to the pivot axis S. The output shaft 46 of the motor 24 and the fluid line 32 are then oriented in this direction.

Supply of the cleaning fluid within the lid 6 to the cleaning head 18 is described below with reference to FIGS. 3 to 5a. Supply of the cleaning fluid from the housing 8, in particular from the pump 30, into the lid 6 is described below with reference to FIGS. 1 and 6 to 10.

As is shown in FIGS. 3 and 4, the fluid line 32 is connected to the bearing arrangement 26. For this purpose, a corresponding connector piece 76 may be provided on the bearing body 50, for example in the form of a reducing nipple, onto which a corresponding connector piece 78 of the fluid line 32 can be plugged. Here, the connector piece 76 is oriented radially with respect to the first axis of rotation D1, but it is also conceivable to implement an axial connection of the fluid line 32.

Furthermore, the bearing arrangement 26 has a fluid chamber 80, which is fluidically connected to the fluid line 32. Preferably, the fluid chamber 80 is formed in the bearing body 50. For assembly reasons among other things, a chamber insert element 82 may be provided for this purpose, which chamber insert element is inserted into the bearing body 50 and has a cavity that forms the fluid chamber 80. The chamber insert element 82 has a first and a second opening through which the rotary shaft 48 extends, and a third opening in connection with the connector piece 76. The rotary shaft 48 passes through the fluid chamber 80, or the fluid chamber 80 surrounds the rotary shaft 48, preferably completely. The fluid chamber 80 is preferably limited by the bearing body 50 or the chamber insert element 82.

The rotary shaft 48 may be formed in sections as a hollow shaft and may have a supply channel 84, which is fluidically connected to the fluid chamber 80 and to the cleaning head 18. The supply channel 84 may be provided mainly in the first end portion 48a of the rotary shaft 48 and in axial direction, for example by an axial bore which extends from the end face of the rotary shaft 48 facing the cleaning head 18 to the height of the fluid chamber 80. A radial opening in the rotary shaft 48 can form a connection of the axial bore to the fluid chamber 80. Consequently, cleaning fluid can flow from the fluid line 32 via the connector piece 76 into the fluid chamber 80 and from the fluid chamber 80 through the supply channel 84 in the rotary shaft 48 into the cleaning head 18.

In the cleaning head 18, the carrier 62 may have a radial bore 86, which is fluidically connected to the supply channel 84, and may have an axial bore 88, which is fluidically connected to the radial bore and the at least one outlet opening 20 or nozzle. In this way, a fluidic connection from the fluid line 32 to the at least one outlet opening 20 is provided. The cap 63 of the cleaning head 18 may have a pin which is plugged or screwed into the axial hole 88 of the carrier 62.

Since the motor 24 and the supply lines (not shown) required for the same are received in the lid 6 together with the bearing arrangement 26, special sealing measures may be provided in order to prevent cleaning fluid from escaping into the interior space 12 of the lid 6 despite the high pressure and the routing of the cleaning fluid through a plurality of partially moved components of the bearing arrangement 26.

In one embodiment, the bearing arrangement comprises a first sealing element 90 and a second sealing element 92 which, in the axial direction of the rotary shaft 48 and with respect to the fluid chamber 80, are arranged on a second side of the second end portion 48b of the rotary shaft 48 and surround the rotary shaft 48. The first sealing element 90 and the second sealing element 92 are arranged spaced apart from each other in the axial direction of the rotary shaft 48. In the axial direction of the rotary shaft 48, the first sealing element 90 may be further away from the fluid chamber 80 than the second sealing element 92. Preferably, the bearing arrangement 26 further comprises a third sealing element 94 which, in the axial direction of the rotary shaft 48 and with respect to the fluid chamber 80, is arranged on a first side of the first end portion 48a of the rotary shaft 48 and surrounds the rotary shaft 48. The first, the second and the third sealing elements 90, 92, 94 are in sealing contact with the rotary shaft 48 and can each be formed as a shaft sealing ring. By the double sealing of the bearing arrangement 26, in particular of the bearing body 50, along the rotary shaft 48 upward towards the interior space 12 of the lid 6 by means of the first and second sealing element 90, 92, escape of cleaning fluid into the interior space 12 can be reliably avoided.

Because of the spaced arrangement of the first and second sealing elements 90, 92, an intermediate space is formed between them. To be able to drain off any cleaning fluid that should penetrate into the intermediate space despite the first sealing element 90, the bearing arrangement 26 may further have a drain opening 96. The drain opening 96 could in principle be connected to a fluid collection device and/or line for draining the cleaning fluid from the lid 6, in particular from the cooking appliance 2. In the present embodiment, however, a fluidic connection is provided between the drain opening 96 and the cooking chamber 4, so that the cleaning fluid can be routed from the intermediate space through the drain openings 96 into the cooking chamber 4. It will be understood that the second sealing element 92 arranged closer to the fluid chamber 80 should be designed such that no cleaning fluid enters the intermediate space during operation, and the first sealing element 90 is substantially provided for protection. In normal operation, there should therefore be no continuous flow of fluid from the drain opening 96 into the cooking chamber 4.

The drain opening 96 may be formed perpendicular to the first axis of rotation D1, for example in the bearing body 50. Easy production is made possible when the bearing arrangement 26 comprises a drain insert element 100, which has the drain opening 96 and is inserted into the bearing body 50. The drain insert element 100 surrounds the rotary shaft 48 and has the drain opening 96 in the form of a bore and/or groove, which passes through the drain insert element 100 in a radial direction. For example, a circumferential groove along the rotary shaft 48 allows cleaning fluid to pass around the rotary shaft 48 to reach the drain opening 96. Preferably, the first and/or second sealing element 90, 92 are in sealing contact with the drain insert element 100, for which purpose the drain insert element 100 may have at least one circumferential seat 102 for receiving the first or second sealing element 90, 92. Here, the drain insert element 100 has the seat 102 for the first sealing element 90, and the chamber insert element 82 has a seat 103 for the second sealing element 92 between the insert elements 82, 100.

The fluidic connection between the drain opening 96 and the cooking chamber 4 may in general be realized in different ways. Preferably, however, the fluidic connection extends within the bearing arrangement 26 into the cleaning head 18, from which the cleaning fluid then escapes, as described below. In this way, it is possible to avoid further coupling points at which the cleaning fluid could escape into the interior space 12 of the lid 6.

Preferably, a drain channel 98 is formed in the bearing body 50 and is fluidically connected to the drain openings 96 and to the cleaning head 18. For this purpose, the drain channel 98 may be directly adjacent to the drain opening 96. For example, the drain channel 98 is formed by a bore in the bearing body 50 parallel to the first axis of rotation D1 and parallel to and spaced apart from the through-opening of the bearing body 50, through which the rotary shaft 48 extends. The drain channel 98 thus opens out at an underside of the bearing body 50.

It is preferred for the fluidic connection from the drain channel 98 into the cooking chamber 4 to lead through the stub 68 and the cleaning head 18. For this purpose, the stub 68 may have a recess surrounding the through-opening 70 and forming a gap between the bearing body 50 and the stub 68, through which gap it is possible for cleaning fluid to flow from the outlet of the drain channel 98 to the through-opening 70. The recess therefore has a diameter which is chosen as a function of the distance of the drain channel 98 from the first axis of rotation D1. The drain opening 96 and the drain channel 98 are thus fluidically connected to the through-opening 70.

As shown, the through-opening 70 of the stub 68 may have a diameter greater than the diameter of the rotary shaft 48, so that cleaning fluid can flow between the stub 68 and the rotary shaft 48 to the cleaning head 18. If there is no sufficient distance between the rotary shaft 48 and the stub 68, for example in the first end portion 48a of the rotary shaft 48 on which the cleaning head 18 is mounted, an inner lateral surface 70a of the through-opening 70 of the stub 68 may have at least one groove 106, which extends parallel to the first axis of rotation D1 and provides a fluidic connection along the rotary shaft 48. As can be seen from FIG. 5b, several grooves 106 may be distributed about the circumference of the inner lateral surface 70a of the through-opening 70. In the axial direction, the at least one groove 106 may be limited to a region in which no sufficient distance can be maintained, or it may extend through the entire stub 68. In the interior of the bearing arrangement 26, cleaning fluid can thus pass through the stub 68 into the cleaning head 18. As can be seen on the left-hand side of the cleaning head 18 in FIG. 5a, the cleaning head 18, for example, between the outlet openings 20 and the second bevel gear wheel 74 and the head piece 60, has cavities and gaps through which the cleaning fluid can pass from the cleaning head into the cooking chamber 4. Overall, a fluidic connection is thus created between the drain opening 96 and the cooking chamber 4.

The course of the fluid line 32, which is formed in particular by a pressure hose, from the bearing arrangement 26 through the hose feed-through 34 to the pump 30, as shown in FIGS. 1 and 3, is described below with reference to FIGS. 6 to 10.

A particularly simple and low-cost structure can be achieved if the fluid line 32 is formed as a flexible pressure hose 32 which extends completely from the bearing arrangement 26 to the pump 30, as is made possible by, among other things, the hose feed-through 34 described herein. In particular, this eliminates the need for complex sealing and coupling devices, which would otherwise be necessary, in particular in the region of the rotary joint 10, in order to convey the cleaning fluid under high pressure from the pump 30 to the bearing arrangement 26. Below, the fluid line 32 is therefore also referred to as pressure hose 32. To provide the cleaning fluid under high pressure, the pressure hose 32 should have a sufficiently high operating and bursting pressure. This is usually associated with an increased stiffness of the pressure hose, so that an advantageous arrangement and routing of the pressure hose 32 within the lid, through the hose feed-through 34 and within the housing 8 permits the use of a stiffer pressure hose 32 and thus utilization of a higher pressure.

As is shown in FIGS. 3, 6a and 6b, the pressure hose 32 extends within the interior space 12 of the lid 6 to the hose feed-through 34 and through the latter into the housing 8 of the cooking appliance 2. While the pressure hose 32 or another fluid line can run within the interior space 12 of the lid 6 and within the housing 8 without any great restrictions, the set-up in the region of the rotary joint 10, which connects the movable lid 6 to the stationary housing 8, is associated with difficulties resulting from relative movements and required sealing measures at high pressure. At this location, the hose feed-through 34 enables simple passage of the pressure hose 32 in the region of the pivot axis S, preferably from the rear side wall 6e of the lid 6 facing the pivot axis S, to the upper side of the housing 8 facing the pivot axis S, in the region of the rotary joint 10 or the rear wall 4a of the cooking chamber.

In a preferred embodiment, the hose feed-through 34 comprises a first element 108 and a second element 110, which form a feed-through for the pressure hose 32 between the lid 6 and the housing 8. The first element 108 is firmly connected to the lid 6, in particular to the rear side wall 6e, and the second element 110 is firmly connected to the housing 8. The first element 108 and the second element 110 are arranged side by side in the axial direction of the pivot axis S and are rotatable relative to each other about the pivot axis S. By virtue of the attachment to the lid 6 by means of the first element 108 and to the housing 8 by means of the second element 110, and of the adjacent arrangement of the two elements 108, 110, the hose feed-through 34 can be formed gap-free, in particular including the transitions to the lid 6 and to the housing 8. For this purpose, the first and the second elements 108, 110 may engage with each other. This can prevent the entry of dirt or water. The first and the second elements 108, 110 may be sleeve-shaped and rigid, e.g. made of metal.

More precisely, the first element 108 may have a first fastening portion 112 and a first axis portion 114. The first axis portion 114 is substantially cylindrical and defines a first cavity 116 about the pivot axis S, i.e. is substantially annular around the pivot axis S. The first fastening portion 112 can form a base or base portion of the first element 108 and is attached to the lid 6, in particular to the side wall 6e thereof. The first fastening portion 112 has a first opening 118 through the first fastening portion 112 between the lid 6 and the first cavity 116. The first opening 118 extends substantially perpendicular to the pivot axis S.

Analogously, the second element 110 may have a second fastening portion 120 and a second axis portion 122. The second axis section 122 is substantially cylindrical and defines a second cavity 124 about the pivot axis S, i.e. is substantially annular about the pivot axis S. The second fastening portion 120 can form a base or base portion of the first element 108 and is attached to the housing 8. The second fastening portion 120 has a second opening 126 through the second fastening portion 120 between the second cavity 124 and the housing 8. The second opening 126 extends substantially perpendicular to the pivot axis S.

Due to the fact that the first element 108 and the second element 110 are adjacent to each other in the axial direction of the pivot axis S, the first cavity 116 and the second cavity 124 form a common cavity about the pivot axis S. The first opening 118 and the second opening 126 are mutually offset in the axial direction of the pivot axis S, but only by the wall thickness of the first and second elements 108, 110 in the region of the openings 118, 126. This means that the pressure hose 32 does not have to be substantially offset or curved in the axial direction of the pivot axis S, and a pressure hose 32 can be used that is as stiff as possible and thus resistant to pressure. Furthermore, this arrangement and the straight routing of the pressure hose 32 from the bearing arrangement 26 to the hose feed-through 34 substantially perpendicular to the pivot axis S, as described above, has the effect that the pressure hose 32 is not subject to torsional moments.

In addition, the first and the second opening 118, 126 are mutually offset by an angle which is preferably, in the open state of the lid 6 (FIG. 6b), between 135° and 270°, more preferably between 160° and 200°, and, in the closed state of the lid 6 (FIG. 6a), about 90°.

As can be seen in FIG. 6b, in the open state of the lid 6, the pressure hose 32 experiences hardly any curvature, whereas, in the closed state of the lid 6 according to FIG. 6a, the pressure hose 32 is arranged in a curved state with a predetermined bending radius. The predetermined bending radius in the closed state of the lid may be between 100 mm and 200 mm, preferably between 130 mm and 170 mm, as a result of which a sufficiently stiff pressure hose 32 can be used. At the same time, when using a pressure hose 32 whose minimum bending radius is smaller than the predetermined bending radius, e.g. between 20 mm and 50 mm, and under dynamic loading, an increased service life is achieved.

When opening and closing the lid 6, the pressure hose 32 is also moved in its longitudinal direction. To allow this movement and also the bending of the pressure hose 32, the diameter of the first and second openings 118 and 126 should be larger than the diameter of the pressure hose. Furthermore, it can be seen from FIG. 6b that, due to the desired stiffness and pressure resistance, the curvature of the pressure hose 32 can extend beyond the hose feed-through 34. Therefore, those sections of the lid 6 and of the housing 8 that are adjacent to the hose feed-through 34 should leave the pressure hose 32 with sufficient space for bending into the predetermined bending radius and sufficient freedom of movement for moving in the longitudinal direction. Furthermore, it is preferred that the pressure hose 32 is not fixed between its ends in the lid 6, the hose feed-through 34 and the housing 8, so as to be able to carry out corresponding yielding movements. The pressure hose 32 can therefore extend from the interior space 12 of the lid 6 through the first opening 118 into the first cavity 116, from the first cavity 116 into the second cavity 124, and from the second cavity 124 through the second opening 126 into the housing 8. By this arrangement, the pressure hose 32 is substantially decoupled from the rotational movement between lid 6 and housing 8 and, in terms of its flexibility, must only execute a bending movement between the open and closed state of the lid 6. In particular, the pressure hose 32 can enter and exit the hose feed-through 34 in the direction in which it extends in the lid 6 and housing 8, such that there is particularly advantageously no need for further deflection of the hose or rotation of the hose about its longitudinal axis. This means that a stiffer and thus more pressure-resistant pressure hose 32 can be used.

Therefore, the hose feed-through 34 is preferably formed substantially independently of the rotary joint 10 between the lid 6 and the housing 8. FIG. 9 shows the region of the rotary joint 10 and of the hose feed-through 34 without the cover shown in FIG. 3. In this embodiment, the rotary joint 10 comprises a first bearing point 128 and a second bearing point 130, which are arranged spaced apart from each other in the axial direction of the pivot axis S. The lid 6 is pivotably mounted at each bearing point 128, 130. For this purpose, the first bearing point 128 may comprise a first axle journal 132 and the second bearing point 130 may comprise a second axle journal 134, wherein the first and the second axle journals 132, 134 are preferably firmly connected to the lid 6, for example by welding. A suitable bearing may be arranged on each axle journal 132, 134, such as a rolling or plain bearing 135 indicated on the axle journal 132, which bearing is received in a bearing bushing (not shown) firmly connected to the housing 8. Alternative embodiments of the rotary joint 10 are known to a person skilled in the art.

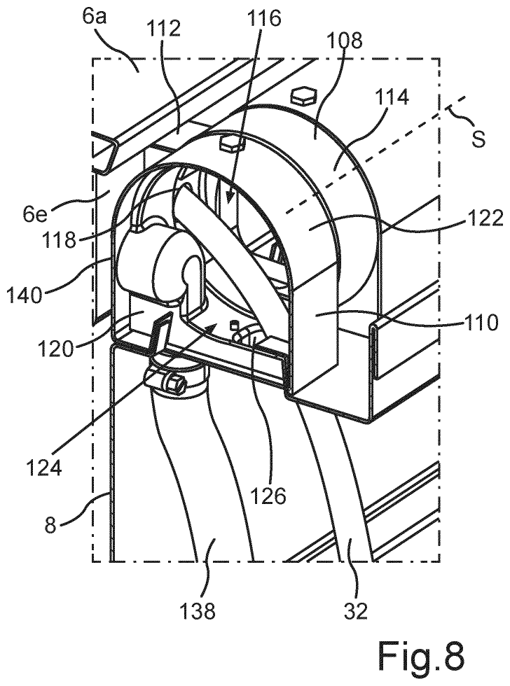

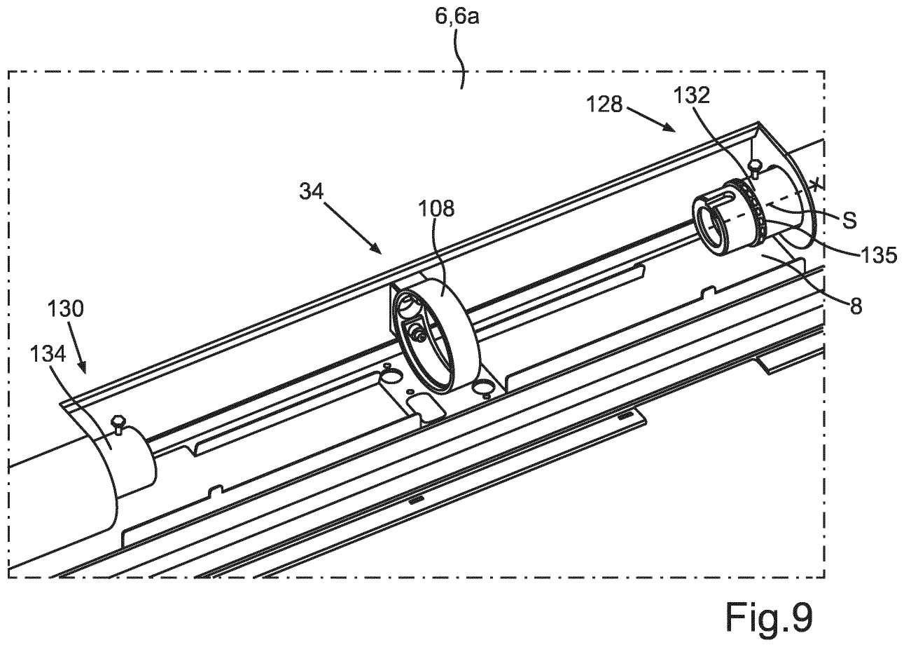

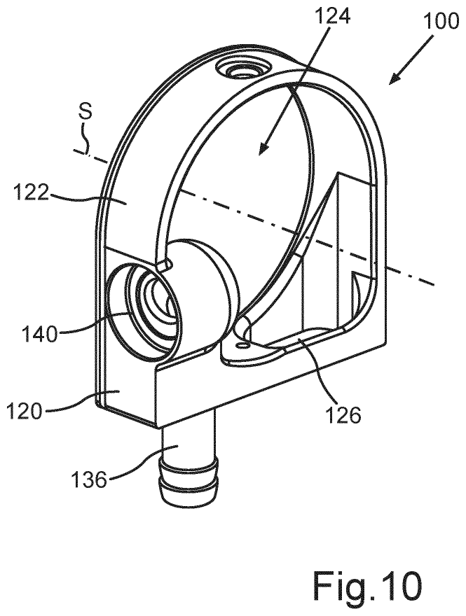

An advantageous embodiment of the second element 110 of the hose feed-through 34 is described below with reference to FIGS. 8 and 10. Accordingly, the second element 110, in the second fastening portion 120, may comprise a connector stub 136 for connecting a water line 138 and may have a discharge opening 140 for discharging water into the cooking chamber 4. The connector stub 136 and the discharge opening 140 are fluidically connected within the second element 110, in this case by way of a substantially L-shaped through-opening. The discharge opening 140 is arranged on an outer surface of the second element 110, which outer surface is directed in the direction of the cooking chamber or pan 4 when the lid 6 is open. The water line 138 is preferably connected to the (domestic) water system. The pan 4 can thus be filled with water for preparing food, for example soups.

To operate the cooking appliance 2, the appropriate foods or ingredients can first be introduced into the cooking chamber 4. If the cooking appliance 2 is used for roasting, the lid 6 can remain open; otherwise the lid 6 is usually closed. The food is then cooked in the cooking chamber 4. In the cooking appliance 2 according to an aspect of the invention, it is possible that the cleaning head 18 of the cleaning device 16 remains permanently mounted on the lid 6 and is located in the cooking chamber 4 when the lid 6 is closed. Preferably, the cleaning head 18 is arranged above the predefined maximum filling level Fmax of the cooking appliance 2. Once cooking is complete, the food can be removed by the user. Automatic cleaning of the cooking chamber 4 can then be carried out by means of the cleaning device 16 and simply has to be started by the user, for example by actuating the control and display devices 11 of the cooking appliance 2. Without any effort being needed on the part of the user to assemble the cleaning head 18, complete cleaning of the cooking chamber 4 can then take place while the user is able to turn to other kitchen tasks.

The cooking appliance 2 according to an aspect of the invention is therefore designed in such a way that it is able to thoroughly clean the cooking chamber 4 and makes things considerably easier for the users, since they do not need to carry out assembly work or cleaning work. Further embodiments of the present invention will be readily apparent to a person in the art based on the description of preferred embodiments contained herein.

1-16. (canceled)

17. A commercial cooking appliance comprising:
a cooking chamber;
a lid for closing the cooking chamber, wherein the lid has an upper side, an underside and at least one side wall, which connects the upper side and the underside, wherein the upper side, the underside and the at least one side wall define an interior space of the lid, wherein the cooking chamber is limited by the underside when the lid is closed;
a cleaning device for cleaning the cooking chamber, wherein the cleaning device is formed as a high-pressure device and is configured to feed a cleaning fluid into the cooking chamber under high pressure, wherein the cleaning device comprises a cleaning head, which has at least one outlet opening for dispensing the cleaning fluid; and
a drive device for rotationally driving the cleaning head, wherein the drive device comprises a motor;
wherein the cleaning head is mounted on the lid to be rotatable about a first axis of rotation; and
wherein the motor of the drive device is received in the interior space of the lid.

18. The commercial cooking appliance of claim 17, wherein the at least one outlet opening is mounted in the cleaning head to be rotatable about a second axis of rotation in such a way that a rotational movement of the cleaning head about the first axis of rotation and a rotational movement of the at least one outlet opening about the second axis of rotation superimpose each other, wherein the second axis of rotation intersects the first axis of rotation at an angle of 90°.

19. The commercial cooking appliance of claim 17, wherein the cleaning device comprises a bearing arrangement which is fixed to the lid and which comprises a rotary shaft which is rotatably mounted, which defines the first axis of rotation and on which the cleaning head is mounted by a torque proof connection.

20. The commercial cooking appliance of claim 19, wherein the drive device comprises a torque transmission device for transmitting a torque from the motor to the rotary shaft, wherein the torque transmission device is received in the interior space of the lid.

21. The commercial cooking appliance of claim 19, wherein the bearing arrangement comprises a stub which surrounds a first end portion of the rotary shaft on which the cleaning head is mounted, the stub having a substantially conical shape between the underside of the lid and the cleaning head.

22. The commercial cooking appliance of claim 21, wherein the at least one outlet opening is mounted in the cleaning head to be rotatable about a second axis of rotation in such a way that a rotational movement of the cleaning head about the first axis of rotation and a rotational movement of the at least one outlet opening about the second axis of rotation superimpose each other, wherein the second axis of rotation intersects the first axis of rotation, and wherein the at least one outlet opening is provided in a carrier which is mounted in the cleaning head to be rotatable about the second axis of rotation and which has a first bevel gear wheel, wherein the stub has a second bevel gear wheel which engages with the first bevel gear.

23. The commercial cooking appliance of claim 17, wherein the cleaning device comprises a fluid line for supplying the cleaning fluid, wherein the fluid line is formed as a high-pressure line and is at least partially received in the interior space of the lid.

24. The commercial cooking appliance of claim 23, wherein the cleaning device comprises a bearing arrangement which is fixed to the lid and which comprises a rotary shaft which is rotatably mounted, which defines the first axis of rotation and on which the cleaning head is mounted by a torque proof connection, and wherein the fluid line is connected to the bearing arrangement, and the bearing arrangement has a fluid chamber fluidically connected with the fluid line, and wherein the rotary shaft is formed in sections as a hollow shaft and has a supply channel, which is fluidically connected to the fluid chamber and to the cleaning head.

25. The commercial cooking appliance of claim 24, wherein the bearing arrangement is received between the motor and the fluid line, wherein the motor and the fluid line are arranged opposite one another with respect to the bearing arrangement.

26. The commercial cooking appliance of claim 17, wherein the cleaning device is configured to provide the cleaning fluid at high pressure, wherein the high pressure is between 40 bar and 300 bar.

27. The commercial cooking appliance of claim 17, wherein the lid comprises a plurality of hollow profiles for stiffening the lid, wherein the motor is received in a hollow profile of the plurality of hollow profiles.

28. The cooking appliance of claim 17, wherein the lid has, on the upper side, a closable access opening through which at least the bearing arrangement is mountable and accessible in the interior space of the lid.

29. The commercial cooking appliance of claim 17, wherein the cooking chamber has a bottom, a rear first wall, a front second wall, a lateral third wall and a lateral fourth wall which limit the cooking chamber, except for an opening that can be closed by the lid, wherein the cleaning head, in the closed state of the lid, is arranged substantially centrally between the first and the second wall and substantially centrally between the second and the third wall.

30. The commercial cooking appliance of claim 17, wherein a distance between a center point of the cleaning head and the underside of the lid is between 15 mm and 50 mm.

31. The commercial cooking appliance of claim 17, wherein a maximum filling level is defined for the cooking chamber, and the cleaning head, in the closed state of the lid, is arranged above the maximum filling level.

32. A method for operating a commercial cooking appliance of claim 17, comprising the steps of:
cooking of a food product in the cooking chamber of the cooking appliance, wherein the cleaning head of the cleaning device is attached firmly to the lid during cooking and is located within the cooking chamber of the cooking appliance;
terminating the cooking process and removing the food product when a desired level of cooking of the food product is reached; and
automatic cleaning of the cooking chamber by means of the cleaning device after removing the food product.
